(19) United States
(12) Patent Application Publication
(10) Pub. No.: US 2017/0329539 A1
(43) Pub. Date: Nov. 16, 2017

(54) DATA WRITING METHOD, MEMORY CONTROL CIRCUIT UNIT AND MEMORY STORAGE DEVICE

(71) Applicant: PHISON ELECTRONICS CORP., Miaoli (TW)

(72) Inventor: Bo-Cheng Ko, Taipei City (TW)

(21) Appl. No.: 15/197,798

(22) Filed: Jun. 30, 2016

(30) Foreign Application Priority Data
May 13, 2016 (TW) 105114857

(51) Int. Cl. G06F 3/06

(52) U.S. Cl. CPC G06F 3/0619; G06F 3/0679; G06F 3/0656; G06F 3/0659

(57) ABSTRACT

A data writing method, a memory control circuit unit and a memory storage device are provided. The method includes: receiving a first write command and writing data corresponding to the first write command into a buffer memory; and writing the data corresponding to the first write command from the buffer memory to at least one first physical programming unit of a first physical erasing unit by using a single page programming mode if a write cache function is disabled and the data of the first write command is stored into the buffer memory, in which the at least one first physical programming unit is constituted by a plurality of first memory cells and each of the first memory cells only stores one bit of data in the single page programming mode.

### CROSS-REFERENCE TO RELATED APPLICATION

This application claims the priority benefit of Taiwan application serial no. 105114857, filed on May 13, 2016. The entirety of the above-mentioned patent application is hereby incorporated by reference herein and made a part of this specification.

### BACKGROUND

### Technical Field

The present invention relates to a data writing method, a memory control circuit unit and a memory storage device.

### Description of Related Art

The growth of digital cameras, mobile phones, and MP3 players has been rapid in recent years. Consequently, the consumers' demand for storage media has increased tremendously. With characteristics including data non-volatility, energy saving, small size, lack of mechanical structures, high reading/writing speed, etc., rewritable non-volatile memories are most suitable for portable electronic products, such as laptops. A solid state drive is a memory storage device which utilizes a flash memory as its storage medium. For these reasons, flash memory has become an important part of the electronic industries.

According to the number of bits that can be stored in each memory cell, the NAND flash memory may be classified into a single level cell (SLC) NAND flash memory, a multi level cell (MLC) NAND flash memory, and a trinary level cell (TLC) NAND flash memory. In which, each memory cell in the SLC NAND flash memory is capable of storing one bit of data (i.e., “1” or “0”), each memory cell in the MLC NAND flash memory is capable of storing two bits of data, and each memory cell in the TLC NAND flash memory is capable of storing three bits of data.

In the NAND flash memory, a physical programming unit is constituted by several memory cells arranged on a same word line. Since each memory cell in the SLC NAND flash memory is capable of storing one bit of data, the several memory cells arranged on the same word line in the SLC NAND flash memory correspond to one physical programming unit.

In contrast with the SLC NAND flash memory, a floating gate storage layer in each memory cell of the MLC NAND flash memory is capable of storing two bits of data, wherein each storage state (i.e., “11”, “10”, “01”, or “00”) includes the least significant bit (LSB) and the most significant bit (MSB). For example, in the storage state, the value of the first bit counted from the left is the LSB, and the value of the second bit counted from the left is the MSB. Accordingly, the several memory cells arranged on the same word line may constitute two physical programming units, wherein the physical programming unit constituted by the LSBs of the memory cells is referred to as a lower physical programming unit, and the physical programming unit constituted by the MSBs of the memory cells is referred to as an upper physical programming unit. It should be noted that, when a failure or an unusual power interruption occurs in the process of programming the upper physical programming unit, the data stored in the lower physical programming unit may be lost. Besides, when the lower physical programming unit has been programmed and the upper physical programming unit corresponding to the lower physical programming unit has not yet been programmed, the data stored in the lower physical programming unit would be in an unstable state due to the characteristics of the MLC NAND flash memory. In such state, the data stored in the lower physical programming unit is also prone to the risk of loss or damage.

Generally, when a memory controller of the rewritable non-volatile memory receives a write command from a host system, the memory controller usually stores data corresponding to the write command into a buffer memory, and replies write completion information corresponding to the write command immediately in response to the write command transmitted by the host system. After that, the memory controller may write the data stored in the buffer memory into the rewritable non-volatile memory at an appropriate moment, for example, when the host system idles for a period of time or the available capacity of the buffer memory is insufficient.

However, in general, a buffer memory is a volatile memory. That is, data stored in the buffer memory may be lost if the power of host system interrupts unusually when the data has been stored into the buffer memory and has not yet been written into the rewritable non-volatile memory.

Accordingly, in general, the loss of the data stored in the buffer memory owing to an unusual power interruption of host system can be prevented by way of using a disable write cache command. In detail, when the memory controller receives a write command from the host system after receiving a disable write cache command from the host system, data corresponding to the write command may be written into the buffer memory, and the memory controller may write the data of the write command from the buffer memory to the rewritable non-volatile memory immediately, so as to reduce the time of the data of the write command staying in the buffer memory, and reduce the risk of data loss.

However, it should be noted that, the data of the write command may not exactly fill the lower physical programming unit and the upper physical programming unit of a single physical programming unit simultaneously. Accordingly, if the data of the write command is only written into the lower physical programming unit while the upper physical programming unit corresponding to the lower physical programming unit is not storing any data, the data stored in the lower physical programming unit would be in an unstable state and prone to the risk of loss due to the characteristics of the MLC NAND flash memory.

Conventionally, in order to prevent the data stored in the lower physical programming unit from being lost due to the aforementioned situation, the memory controller may write dummy data into the upper physical programming unit to keep the lower physical programming unit in a stable state, so as to assure the data in the lower physical programming unit is stored completely and stably. However, after receiving the disable write cache command from the host system, the memory controller may write too much dummy data into the rewritable non-volatile memory due to numerous write commands, and thus causing a problem of “write amplification” generally called by people skilled in the art. This problem causes a low efficiency of the rewritable non-volatile memory.

Based on the above, how to prevent the loss of the data stored in the buffer memory owing to an unusual power interruption of host system, assuring the data of the write command is stably stored into the rewritable non-volatile memory before the unusual power interruption, and effectively utilizing the space of the rewritable non-volatile memory are still goals to be achieved for technicians of the art.

Nothing herein should be construed as an admission of knowledge in the prior art of any portion of the present invention. Furthermore, citation or identification of any document in this application is not an admission that such document is available as prior art to the present invention, or that any reference forms a part of the common general knowledge in the art.

### SUMMARY

The present invention provides a data writing method, a memory control circuit unit and a memory storage device capable of preventing data loss owing to an unusual power interruption of a host system, and utilizing storage capacity of rewritable non-volatile memories effectively.

According to an exemplary embodiment, a data writing method for a rewritable non-volatile memory module is provided. The rewritable non-volatile memory module includes a plurality of physical erasing units. Each of the physical erasing units includes a plurality of physical programming units. The data writing method includes receiving a first write command from a host system and storing data corresponding to the first write command into a buffer memory. The data writing method also includes writing the data corresponding to the first write command from the buffer memory to at least one first physical programming unit of a first physical erasing unit among the physical erasing units by using a single page programming mode when a write cache function is disabled and the data of the first write command is stored into the buffer memory. Herein, the at least one first physical programming unit is constituted by a plurality of first memory cells and each of the first memory cells only stores one bit of data in the single page programming mode.

According to an exemplary embodiment, a memory control circuit unit for controlling a rewritable non-volatile memory module is provided. The memory control circuit unit includes a host interface configured to couple to a host system and a memory interface configured to couple to the rewritable non-volatile memory module. Herein, the rewritable non-volatile memory module includes a plurality of physical erasing units, and each of the physical erasing units includes a plurality of physical programming units. The memory control circuit further includes a buffer memory coupled to the host interface and the memory interface. The memory control circuit also includes a memory management circuit coupled to the host interface, the memory interface and the buffer memory. The memory management circuit is configured to receive a first write command from the host system and store data corresponding to the first write command into the buffer memory. The memory management circuit is also configured to issue a first command sequence to write the data corresponding to the first write command from the buffer memory to at least one first physical programming unit of a first physical erasing unit among the physical erasing units by using a single page programming mode when a write cache function is disabled and the data of the first write command is stored into the buffer memory. Herein, the at least one first physical programming unit is constituted by a plurality of first memory cells and each of the first memory cells only stores one bit of data in the single page programming mode.

According to an exemplary embodiment, a memory storage device is provided. The memory storage device includes a connection interface unit configured to couple to a host system, a rewritable non-volatile memory module, and a memory control circuit unit configured to couple to the connection interface unit and the rewritable non-volatile memory module. Herein, the memory control circuit unit includes a buffer memory, the rewritable non-volatile memory module includes a plurality of physical erasing units, and each of the physical erasing units includes a plurality of physical programming units. The memory control circuit unit is configured to receive a first write command from the host system and store data corresponding to the first write command into the buffer memory. The memory control circuit unit is also configured to issue a first command sequence to write the data corresponding to the first write command from the buffer memory to at least one first physical programming unit of a first physical erasing unit among the physical erasing units by using a single page programming mode when a write cache function is disabled and the data of the first write command is stored into the buffer memory. Herein, the at least one first physical programming unit is constituted by a plurality of first memory cells and each of the first memory cells only stores one bit of data in the single page programming mode.

To sum up, the data writing method of the present invention can effectively prevent the loss of data stored in the buffer memory owing to an unusual power interruption of the host system, assure that data of the write command is stably stored into the rewritable non-volatile memory before the unusual power interruption, and effectively utilize the capacity of the rewritable non-volatile memory.

To make the above features and advantages of the present invention more comprehensible, several embodiments accompanied with drawings are described in detail as follows.

It should be understood, however, that this Summary may not contain all of the aspects and embodiments of the present invention, is not meant to be limiting or restrictive in any manner, and that the invention as disclosed herein is and will be understood by those of ordinary skill in the art to encompass obvious improvements and modifications thereto.

### BRIEF DESCRIPTION OF THE DRAWINGS

The accompanying drawings are included to provide a further understanding of the present invention, and are incorporated in and constitute a part of this specification. The drawings illustrate embodiments of the invention and, together with the description, serve to explain the principles of the invention.

FIG. 1 is a schematic diagram illustrating a host system, a memory storage device and an input/output (I/O) device according to an exemplary embodiment.

FIG. 2 is a schematic diagram illustrating a host system, a memory storage device and an input/output (I/O) device according to another exemplary embodiment.

FIG. 3 is a schematic diagram illustrating a host system and a memory storage device according to another exemplary embodiment.

FIG. 4 is a schematic block diagram illustrating a host system and a memory storage device according to an exemplary embodiment.

FIG. 5A and FIG. 5B are exemplary schematic diagrams illustrating examples of a memory cell storage structure and a physical erasing unit according to an exemplary embodiment of the present invention.

FIG. 6 is a schematic block diagram illustrating a memory control circuit unit according to an exemplary embodiment.

FIG. 7 and FIG. 8 are exemplary schematic diagrams illustrating examples of managing the physical erasing units according to an exemplary embodiment.

FIG. 9 is a schematic diagram of writing data into a rewritable non-volatile memory module by using a single page programming mode according to an exemplary embodiment.

FIG. 10 is a schematic diagram of performing a valid data merging operation to data written in a single page programming mode by using a multi-page programming mode according to an exemplary embodiment.

FIG. 11 and FIG. 12 are flowcharts of a data writing method according to an exemplary embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments of the present invention may comprise any one or more of the novel features described herein, including in the Detailed Description, and/or shown in the drawings. As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

Generally speaking, a memory storage device (i.e. a memory storage system) includes a rewritable non-volatile memory module and a controller (i.e. a control circuit unit). The memory storage device is usually used together with a host system, such that the host system can write data into or read data from the memory storage device.

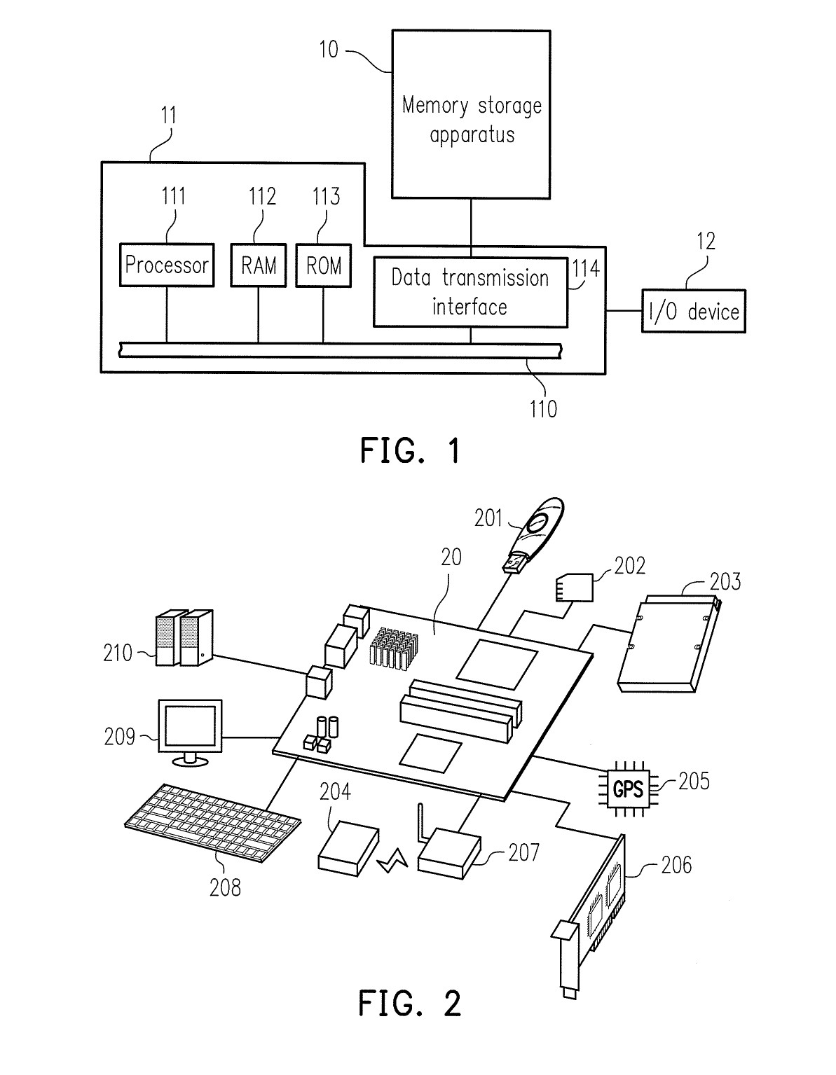

FIG. 1 is a schematic diagram illustrating a host system, a memory storage device and an input/output (I/O) device according to an exemplary embodiment, and FIG. 2 is a schematic diagram illustrating a host system, a memory storage device and an I/O device according to another exemplary embodiment of the present invention.

Referring to FIG. 1 and FIG. 2, a host system 11 generally includes a processor 111, a random access memory (RAM) 112, a read only memory (ROM) 113 and a data transmission interface 114. The processor 111, the RAM 112, the ROM 113 and the data transmission interface 114 are coupled to a system bus 110.

In the present exemplary embodiment, the host system 11 is coupled to a memory storage device 10 through the data transmission interface 114. For example, the host system 11 may write data into the memory storage device 10 or read data from the memory storage device 10 through the data transmission interface 114. Further, the host system 111 is coupled to an I/O device 12 through the system bus 110. For example, the host system 11 may transmit an output signal to the I/O device 12 or receive an input signal from I/O device 12 through the system bus 110.

In the present exemplary embodiment, the processor 111, the RAM 112, the ROM 113 and the data transmission interface 114 may be disposed on a main board 20 of the host system 11. The number of the data transmission interface 114 may be one or a plurality. Through the data transmission interface 114, the main board 20 may be coupled to the memory storage device 10 in a wired manner or a wireless manner. The memory storage device 10 may be, for example, a flash drive 201, a memory card 202, a solid state drive (SSD) 203 or a wireless memory storage device 204. The wireless memory storage device 204 may be, for example, a memory storage device based on various wireless communication technologies, such as a near field communication storage (NFC) memory storage device, a WiFi memory storage device, a Bluetooth memory storage device, a low energy (LE) Bluetooth memory storage device (e.g., iBeacon). Further, the main board 20 may also be coupled to various I/O devices, such as a global positioning system (GPS) module 205, a network interface card 206, a wireless transmission device 207, a keyboard 208, a monitor 209 and a speaker 210 through the system bus 110. For example, in an exemplary embodiment, the main board 20 can access the wireless memory storage device 204 through the wireless transmission device 207.

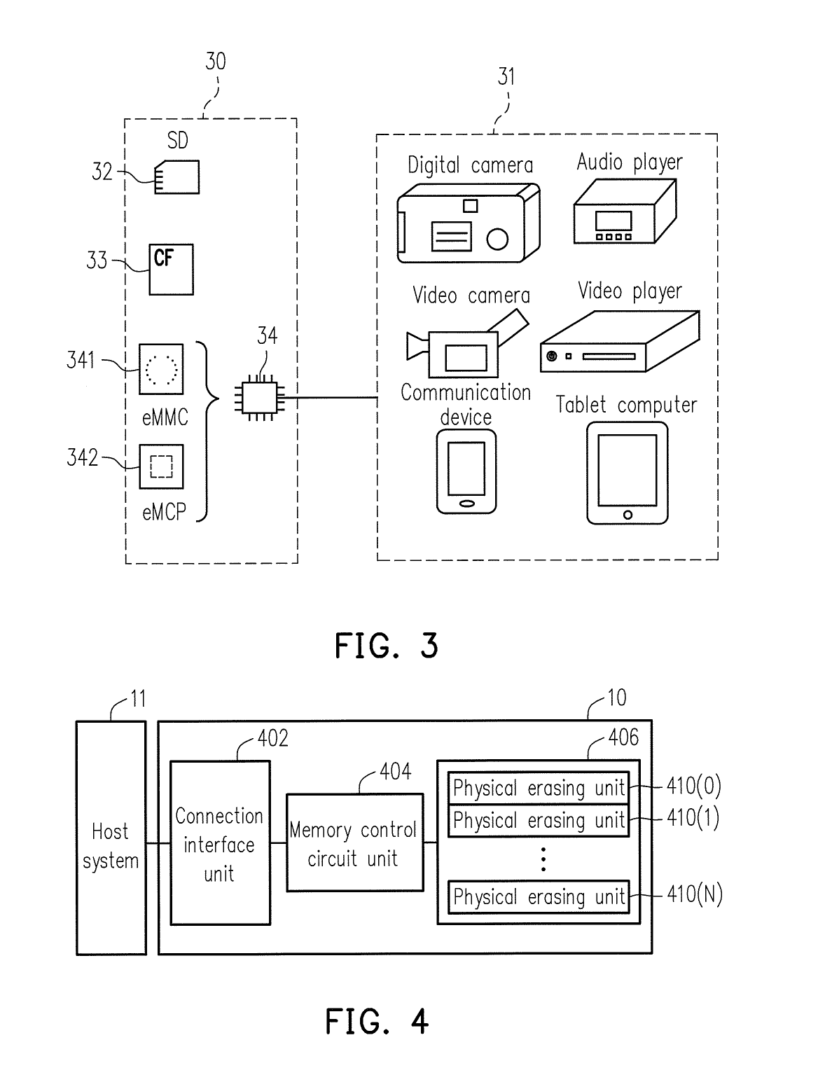

In an exemplary embodiment, the aforementioned host system may be any system capable of substantially cooperating with the memory storage device for storing data. Although the host system is illustrated as a computer system in foregoing exemplary embodiment; however, FIG. 3 is a schematic diagram illustrating a host system and a memory storage device according to another exemplary embodiment. Referring to FIG. 3, in another exemplary embodiment, a host system 31 may also be a system including a digital camera, a video camera, a communication device, an audio player, a video player or a tablet computer, whereas a memory storage device 30 can be various non-volatile memory devices used by the host system, such as a SD card 32, a CF card 33 or an embedded storage device 34. The embedded storage device 34 may include an embedded MMC (eMMC) 341 and/or an embedded multi chip package (eMCP) 342, in which a memory module is directly coupled to a substrate of the host system.

FIG. 4 is a schematic block diagram illustrating a host system and a memory storage device according to an exemplary embodiment.

Referring to FIG. 4, the memory storage device 10 includes a connection interface unit 402, a memory control circuit unit 404 and a rewritable non-volatile memory module 406.

In the present exemplary embodiment, the connection interface unit 402 is compatible with a serial advanced technology attachment (SATA) standard. Nevertheless, it should be understood that the present invention is not limited thereto. The connection interface unit 402 may also be compatible to a parallel advanced technology attachment (PATA) standard, an institute of electrical and electronic engineers (IEEE) 1394 standard, a peripheral component interconnect express (PCI Express) interface standard, a universal serial bus (USB) standard, an ultra high speed-I (UHS-I) interface standard, an ultra high speed-II (UHS-II) interface standard, a secure digital (SD) interface standard, a memory stick (MS) interface standard, a multi-chip package interface standard, a multi media card (MMC) interface standard, an embedded multimedia card (eMMC) interface standard, a universal flash storage (UFS) interface standard, an embedded multi-chip package (eMCP) interface standard, a compact flash (CF) interface standard, an integrated device electronics (IDE) standard, or other suitable standards. In the present exemplary embodiment, the connection interface unit 402 may be packaged with the memory control circuit unit 404 in one chip or laid outside a chip including the memory control circuit unit.

The memory control circuit unit 404 is configured to execute a plurality of logic gates or control instructions which are implemented in form of hardware or firmware, so as to perform operations of writing, reading or erasing data in the rewritable non-volatile memory storage module 406 according to commands issued by the host system 11.

The rewritable non-volatile memory module 406 is coupled to the memory control circuit unit 404 and configured to store data written from the host system 11. The rewritable non-volatile memory storage module 406 includes multiple physical erasing units 410(0) to 410(N). Each of the physical erasing units includes a plurality of physical programming units, and the physical programming units belonging to the same physical erasing unit may be written separately but erased altogether at the same time. However, it should be understood that the present invention is not limited thereto, and each of the physical erasing units may be composed of 64, 256 or any other number of physical programming units.

In detail, a physical erasing unit is the smallest unit for erasing. Namely, each physical erasing unit has the least number of memory cells to be erased altogether. A physical programming unit is the smallest unit for programming. Namely, the physical programming unit is the smallest unit for writing data. Each of the physical programming units generally includes a data bit area and a redundant bit area. The data bit area includes a plurality of physical access addresses for storing user data, and the redundant bit area is configured to store system data (e.g., control information and error correcting codes). In the present exemplary embodiment, the data bit area of each physical programming unit contains 8 physical access addresses, and the size of each physical access address is 512 bytes. However, in other exemplary embodiments, the data bit area may contain more or less number of physical access addresses, and the number and the size of the physical access addresses are not limited in the present invention. For instance, in an exemplary embodiment, the physical erasing units are physical blocks, and the physical programming units are physical pages or physical sectors, which are not limited in the present invention.

In the present exemplary embodiment, the rewritable non-volatile memory module 406 is a multi level cell (MLC) NAND flash memory module (i.e., a flash memory module capable of storing 2 bits of data in one memory cell). However, the invention is not limited thereto, and the rewritable non-volatile memory module 406 may also be a single-level cell (SLC) NAND flash memory module (i.e., a flash memory module capable of storing 1 bit of data in one memory cell), a trinary-level cell (TLC) NAND flash memory module (i.e., a flash memory module capable of storing 3 bits of data in one memory cell), any other flash memory module, or any other memory module with the same characteristics.

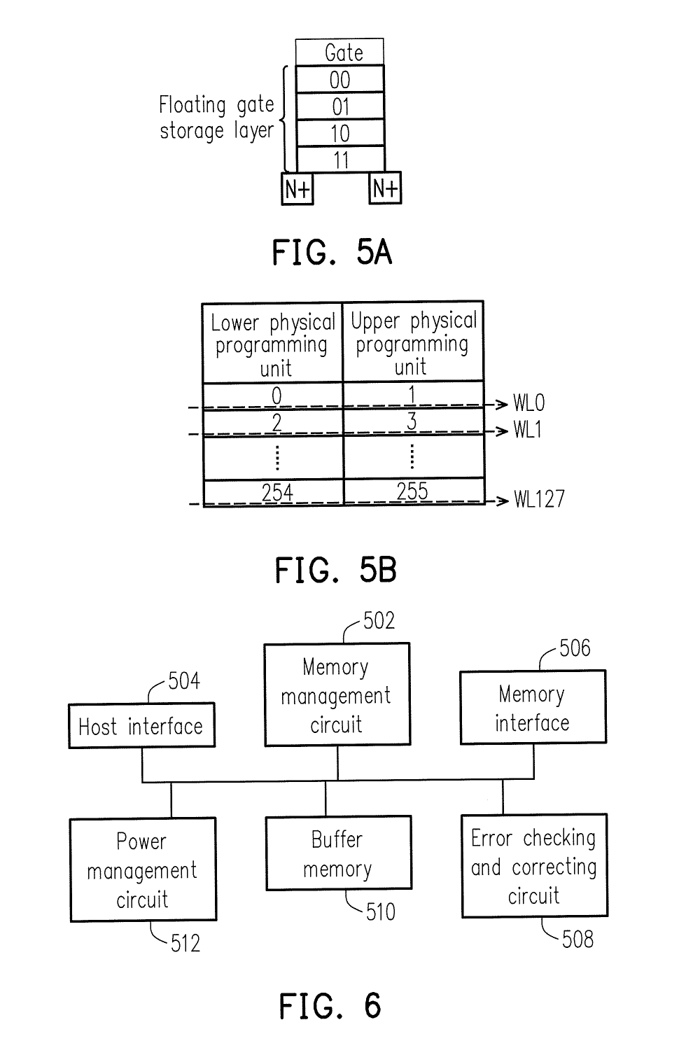

FIG. 5A and FIG. 5B are exemplary schematic diagrams illustrating examples of a memory cell storage structure and a physical erasing unit according to an exemplary embodiment of the present invention. In the present exemplary embodiment, an MLC NAND flash memory is illustrated as an example for description.

Referring to FIG. 5A, each memory cell in the rewritable non-volatile memory module 406 is capable of storing two bits of data, and a storage state of each memory cell can be identified as “11”, “10”, “01”, or “00”. In which, each storage state includes the least significant bit (LSB) and the most significant bit (MSB). For example, in the storage state, the value of the first bit counted from the left is the LSB, and the value of the second bit counted from the left is the MSB. Accordingly, the memory cells connected to the same word line may constitute two physical programming units, in which the physical programming unit constituted by the LSBs of the memory cells is referred to as a lower physical programming unit, and the physical programming unit constituted by the MSBs of the memory cells is referred to as an upper physical programming unit.

Referring to FIG. 5B, a physical erasing unit is constituted by a plurality of physical programming unit groups, and each physical programming unit group includes the lower physical programming unit and the upper physical programming unit constituted by the memory cells arranged on the same word line. For example, in the physical erasing unit, a 0^{th} physical programming unit belonging to the lower physical programming unit and a 1^{st} physical programming unit belonging to the upper physical programming unit are constituted by the memory cells arranged on word line WL0, therefore being regarded as one physical programming unit group. Similarly, the 2^{nd} and 3^{rd} physical programming units are constituted by the memory cells arranged on word line WL1, therefore being regarded as one physical programming unit group, and the other physical programming units are grouped to a plurality of physical programming unit groups in the same way.

FIG. 6 is a schematic block diagram illustrating a memory control circuit unit according to an exemplary embodiment.

Referring to FIG. 6, the memory control circuit unit 404 includes a memory management circuit 502, a host interface 504, a memory interface 506, a buffer memory 508, a power management circuit 510, and an error checking and correcting circuit 512.

The memory management circuit 502 is configured to control overall operations of the memory control circuit unit 404. Specifically, the memory management circuit 502 has a plurality of control instructions. When the memory storage device 10 is operated, the control instructions are executed to perform various data operation such as data writing, data reading and data erasing.

In the present exemplary embodiment, the control instructions of the memory management circuit 502 are implemented in form of firmware. For instance, the memory management circuit 502 has a microprocessor (not shown) and a read-only memory (not shown), and the control instructions are burnt into the read-only memory. When the memory storage device 10 is operated, the control instructions are executed by the microprocessor for various data operations, such as data writing, data reading or data erasing.

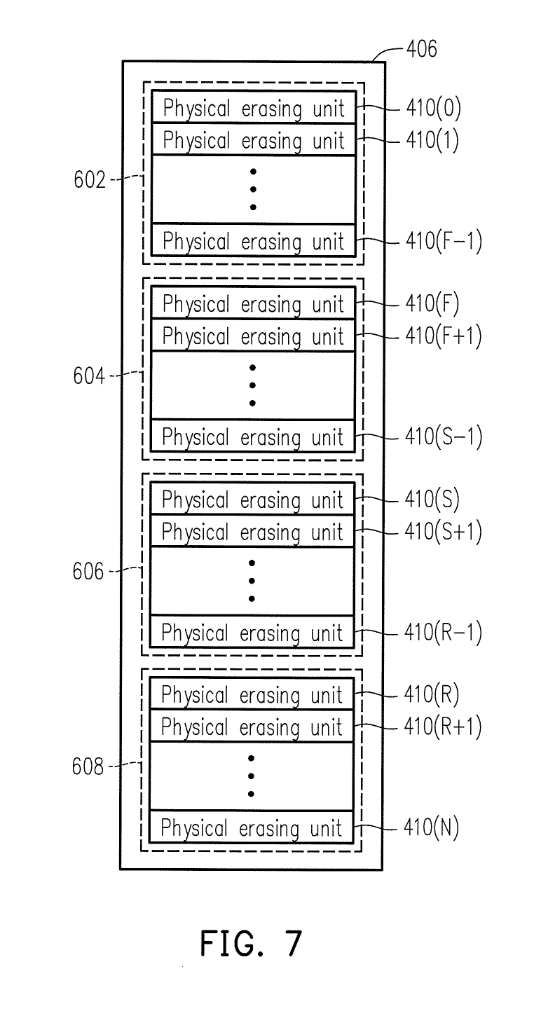

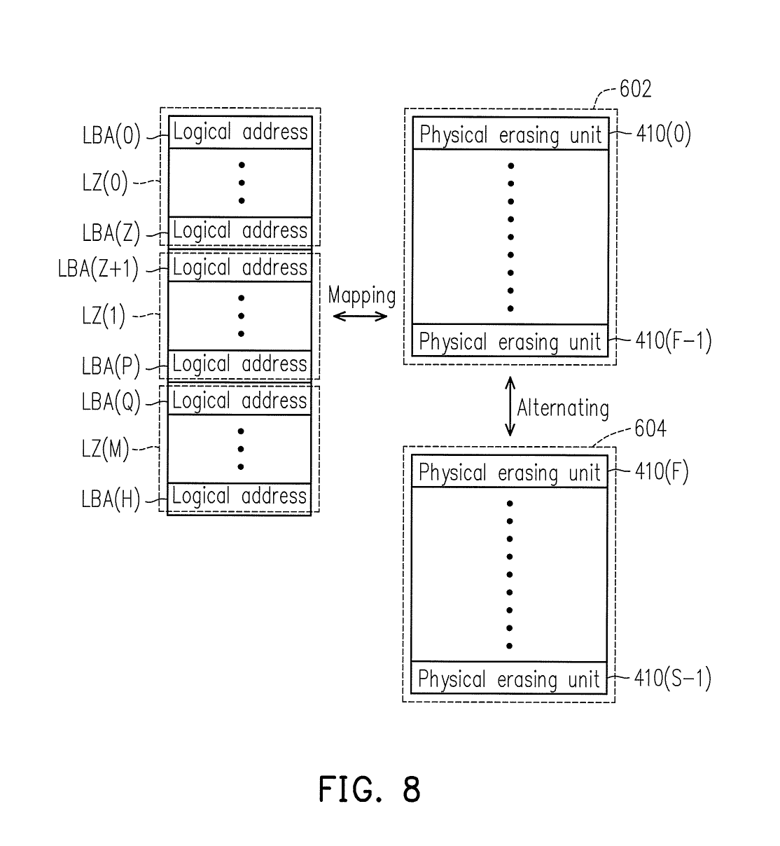

FIG. 7 and FIG. 8 are exemplary schematic diagrams illustrating examples of managing the physical erasing units according to an exemplary embodiment.

It should be understood that terms, such as “get”, “select”, “group”, “divide”, “associate” and so forth, are logical concepts which describe operations in the physical erasing units of the rewritable non-volatiles memory module 406. That is, the physical erasing units of the rewritable non-volatile memory module are logically operated, but actual positions of the physical units of the rewritable non-volatile memory module are not changed.

Referring to FIG. 7, the memory control circuit unit 404 (or the memory management circuit 502) may logically group the physical erasing units 410(0) to 410(N) into a data area 602, a spare area 604, a system area 606 and a replacement area 608.

The physical erasing units logically belonging to the data area 602 and the spare area 604 are configured to store data from the host system 11. To be specific, the physical erasing units of the data area 602 are considered as the physical erasing units which have been used for storing data, and the physical erasing units of the spare area 604 are used for replacing the physical erasing units of the data area 602. Namely, when a write command and data to be written are received from the host system 11, the memory management circuit 502 selects a physical erasing unit from the spare area 604 and writes the data into the selected physical erasing unit to replace the physical erasing unit of the data area 602.

The physical erasing units logically belonging to the system area 606 are configured to record system data. For instance, the system data includes the manufacturers and models of the rewritable non-volatile memory module, the number of physical erasing units in the rewritable non-volatile memory module, the number of physical programming units in each physical erasing unit, and so on.

The physical erasing units logically belonging to the replacement area 608 are used in a bad physical erasing unit replacement procedure for replacing damaged physical erasing units. Specifically, if there are still normal physical erasing units in the replacement area 608, and a physical erasing unit in the data area 602 is damaged, the memory management circuit 502 selects a normal physical erasing unit from the replacement area 608 to replace the damaged physical erasing unit.

Particularly, the numbers of the physical erasing units in the data area 602, the spare area 604, the system area 606 and the replacement area 608 vary with different memory module specifications. In addition, it should be understood that, during operations of the memory storage device 10, grouping relations of the physical erasing units for associating with the data area 602, the spare area 604, the system area 606, and the replacement area 608 may be dynamically changed. For example, when a damaged physical erasing unit in the spare area 604 is replaced by a physical erasing unit in the replacement area 608, the physical erasing unit which is previously in the replacement area 608 is associated with the spare area 604.

Referring to FIG. 8, the memory control circuit unit 404 (or the memory management circuit 502) configures logical addresses LBA(0) to LBA(H) for mapping the physical erasing units in the data area 602, in which each logical address has a plurality of logical units for mapping the physical programming units of the corresponding physical erasing unit. Moreover, when the host system 11 is to write data to a logical address or update data stored in the logical address, the memory control circuit unit 404 (or the memory management circuit 502) selects a physical erasing unit from the spare area 604 as an active physical unit for writing the data to substitute for the physical erasing unit in the data area 602. In addition, when the physical erasing unit as the active physical unit is fully written, the memory control circuit unit 404 (or the memory management circuit 502) may select an empty physical erasing unit from the spare area 604 as the active physical unit to continue writing update data corresponding to the write command from the host system 11. In addition, when the number of the physical erasing units available in the spare area 604 is smaller than a predetermined value, the memory control circuit unit 404 (or the memory management circuit 502) performs a valid data merging operation (also referred to as a garbage collection operation) to organize valid data in the data area 602 and re-associate the physical erasing units not stored with the valid data in the data area 602 to the spare area 604.

To identify in which physical erasing units the data of each logical address is stored, in the present exemplary embodiment, the memory control circuit unit 404 (or the memory management circuit 502) records mappings between the logical addresses and the physical erasing units. For example, in the present exemplary embodiment, the memory control circuit unit 404 (or the memory management circuit 502) stores a logical address-physical address mapping table in the rewritable non-volatile memory module 406 to record the physical erasing unit mapped to each logical address. When data is to be accessed, the memory control circuit unit 404 (or the memory management circuit 502) loads the logical address-physical address mapping table to the buffer memory 508 for maintenance and writes or reads data according to the logical address-physical address mapping table.

It should be mentioned that due to limited capacity, the buffer memory 508 is unable to store the mapping tables recording the mapping relations of all logical addresses. Therefore, in the present exemplary embodiment, the memory control circuit unit 404 (or the memory management circuit 502) groups the logical addresses LBA(0) to LBA(H) into a plurality of logical zones LZ(0) to LZ(M) and allocates one logical address-physical address mapping table to each logical zone. Particularly, if the memory control circuit unit 404 (or the memory management circuit 502) is to update the mapping of one certain logical address, the logical address-physical address mapping table corresponding to the logical zone of the logical address is loaded to the buffer memory 508 to be updated.

According to another exemplary embodiment, the control instructions of the memory management circuit 502 may also be stored in a specific area (for example, the system area in the memory module exclusively used for storing system data) of the rewritable non-volatile memory module 406 as program codes. Moreover, the memory management circuit 502 has a microprocessor unit (not shown), a read-only memory (not shown), and a random access memory (not shown). Particularly, the read only memory includes a boot code, and when the memory control circuit unit 404 is enabled, the microprocessor unit first executes the boot code segment to load the control instructions stored in the rewritable non-volatile memory module 406 to the random access memory of the memory management circuit 502. Afterwards, the microprocessor unit executes the control instructions for various data operation such as data writing, data reading and data erasing.

Furthermore, in another exemplary embodiment, the control instructions of the memory management circuit 502 may also be implemented in a hardware form. For example, the memory management circuit 502 includes a micro controller, a memory cell management circuit, a memory writing circuit, a memory reading circuit, a memory erasing circuit, and a data processing circuit. The memory cell management circuit, the memory writing circuit, the memory reading circuit, the memory erasing circuit, and the data processing circuit are coupled to the micro controller. In which, the memory cell management circuit is configured to manage the physical erasing units of the rewritable non-volatile memory module 406. The memory writing circuit is configured to issue a write command to the rewritable non-volatile memory module 406 for writing data to the rewritable non-volatile memory module 406. The memory reading circuit is configured to issue a read command to the rewritable non-volatile memory module 406 for reading data from the rewritable non-volatile memory module 406. The memory erasing circuit is configured to issue an erase command to the rewritable non-volatile memory module 406 for erasing data from the rewritable non-volatile memory module 406. The data processing circuit is configured to process data to be written to the rewritable non-volatile memory module 406 and data read from the rewritable non-volatile memory module 406.

Referring to FIG. 6 again, the host interface 504 is coupled to the memory management circuit 502 and is configured to couple to the connection interface unit 402 to receive and identify the commands and the data transmitted by the host system 11. In other words, the commands and the data transmitted by the host system 11 are transmitted to the memory management circuit 502 via the host interface 504. In the present exemplary embodiment, the host interface 504 is compatible with the SATA standard. However, it should be understood that the invention is not limited hereto, and the host interface 504 may also be compatible with the PATA standard, the IEEE 1394 standard, the PCI Express standard, the USB standard, the UHS-I interface standard, the UHS-II interface standard, the SD standard, the MS standard, the MMC standard, the CF standard, the IDE standard, or other suitable data transmission standards.

The memory interface 506 is coupled to the memory management circuit 502 for accessing the rewritable non-volatile memory module 406. In other words, data desired to be written into the rewritable non-volatile memory module 406 is converted as an acceptable foil lat to the rewritable non-volatile memory module 406 by the memory interface 506.

The buffer memory 508 is coupled to the memory management circuit 502 and is configured to temporarily store the data and the commands from the host system 11 or the data from the rewritable non-volatile memory module 406.

The power management circuit 510 is coupled to the memory management circuit 502 and configured for controlling the power of the of the memory storage device 10.

The error checking and correcting circuit 512 is coupled to the memory management circuit 502 and is configured to execute an error checking and correcting procedure to ensure correctness of the data. For example, when the memory management circuit 502 receives a write command from the host system 11, the error checking and correcting circuit 512 generates an error checking and correcting code (ECC Code) for the data corresponding to the write command, and the memory management circuit 502 writes the data corresponding to the write command and the corresponding error checking and correcting code to the rewritable non-volatile memory module 406. Afterwards, when reading the data from the rewritable non-volatile memory module 406, the memory management circuit 502 simultaneously reads the error checking and correcting code corresponding to the data, and the error checking and correcting circuit 512 executes the error checking and correcting procedure on the read data according to the error checking and correcting code.

It should be mentioned that, in the present exemplary embodiment, the memory control circuit unit 404 (or memory management circuit 502) may program data into the rewritable non-volatile memory module 406 by using different programming modes in different states. For example, the memory control circuit unit 404 (or memory management circuit 502) may program data into the physical erasing unit by using a single page programming mode or a multi-page programming mode. The programming speed of programming memory cells based on the single page programming mode is higher than the programming speed of programming memory cells based on the multi-page programming mode (i.e., the operation time for programming data by using the multi-page programming is longer than the operation time for programming data by using the single page programming mode). And, the reliability of the data stored basing on the single page programming mode is often higher than the reliability of the data stored basing on the multi-page programming mode. The single page programming mode is, for example, one of a single level memory cell (SLC) programming mode, a lower physical programming mode, a mixture programming mode and a less layer memory cell programming mode. In more detail, each memory cell stores only one bit of data in the SLC mode. In the lower physical programming mode, only the lower physical programming unit is programmed, whereas the upper physical programming unit corresponding to the lower physical programming unit is not programmed. In the mixture programming mode, valid data (or real data) is programmed into the lower physical programming unit, and dummy data is programmed into the upper physical programming unit corresponding to the lower physical programming unit storing the valid data. In the less layer memory mode, each memory cell stores a first number of bits of data. For example, the first number may be set as 1. The multi-page programming mode is, for example, a MLC programming mode, a TLC programming mode, or the like. In the multi-page programming mode, each memory cell stores a second number of bits of data, in which the second number is greater or equal to 2. For example, the second number may be set as 2 or 3. In another exemplary embodiment, the aforementioned first number in the single page programming mode and the aforementioned second number in the multi-page programming mode can be other numbers under the premise of the second number is greater than the first number. In other words, the number of bit of data storing in each memory cell constituting a first type of physical erasing unit after the memory cell has programmed by the single page programming mode (i.e., the first number) is smaller than the number of bit of data storing in each memory cell constituting a second type of physical erasing unit after the memory cell has programmed by the multi-page programming mode (i.e., the second number).

In the present exemplary embodiment, the memory control circuit unit 104 (or memory management circuit 502) is preset to write data to the rewritable non-volatile memory module 406 by using the multi-page programming mode after the host system 11 and the rewritable non-volatile memory module power on. Specifically, if the memory control circuit unit 104 (or memory management circuit 502) receives a write command (referred to as second write command hereafter) from the host system 11, the memory control circuit unit 104 (or memory management circuit 502) may store data corresponding to the write command into the buffer memory 508 first and immediately transmit write completion information corresponding to the second write command to the host system 11. Afterwards, for example, when the memory control circuit unit 104 (or memory management circuit 502) receives a flush command from the host system 11 or the amount of data in the buffer memory 508 reaches a threshold or the idle time of the host system 11 exceeds a threshold, the memory control circuit unit 104 (or memory management circuit 502) may issue a second command sequence to write the data corresponding to the second write command stored in the buffer memory 508 into at least one physical programming unit (referred to as second physical programming unit hereafter) of a physical erasing unit (referred to as second physical erasing unit hereafter) of the rewritable non-volatile memory module 406 by using the multi-page programming mode. Herein, the second physical erasing unit is programmed by the multi-page programming mode. Accordingly, the memory cell constituting the physical programming unit of the second physical erasing unit is programmed to store multiple bits of data as mentioned above. That is, in the multi-page programming mode, both the lower physical programming unit of the second physical erasing unit and the upper physical programming unit of the second physical erasing unit are used to write data.

However, it should be noted that, in order to avoid the loss of the data stored in the buffer memory owing to an unusual interruption of the host system. In the present exemplary embodiment, user may issue a disable write cache command by the host system 11 to disable a write cache function of the memory storage device 10. Specifically, the time for which the data of the write command storing in the buffer memory 508 may be reduced by disabling the write cache function. In other words, in a case where the memory control circuit unit 104 (or memory management circuit 502) disables the write cache function according the disable write cache command, when the host system 11 issues a write command, the data of the write command is written into the rewritable non-volatile memory module 406 right after being stored into the buffer memory 508.

Besides, after receiving the disable write cache command from the host system 11, the memory control circuit unit 104 (or memory management circuit 502) may write too much dummy data due to numerous write commands, and thus causing a problem of “write amplification”. In order to avoid the problem of write amplification and effectively utilize the storage capacity of the rewritable non-volatile memory module 406, in the present exemplary embodiment, the memory control circuit unit 104 (or memory management circuit 502) may use the single page programming mode to write data into the rewritable non-volatile memory module 406 after receiving the disable write cache command from the host system 11 instead.

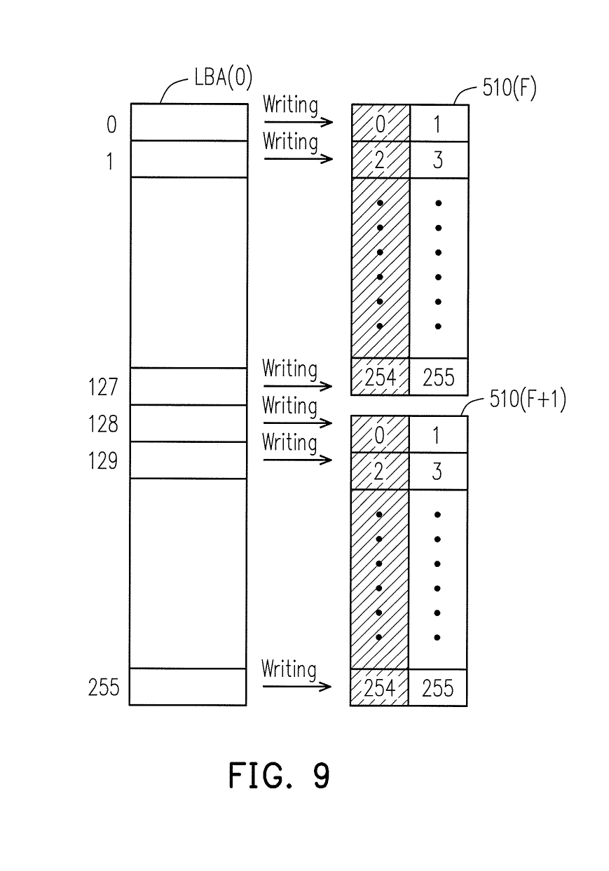

Specifically, FIG. 9 is a schematic diagram of writing data into a rewritable non-volatile memory module by using a single page programming mode according to an exemplary embodiment.

It is assumed that the memory control circuit unit 104 (or memory management circuit 502) receives a disable write cache command from the host system 11. After receiving the disable write cache command, the memory control circuit unit 104 (or memory management circuit 502) may disable a write cache function in response to the disable write cache command. Afterwards, when the memory storage device 10 receives from the host system 11 a write command (hereinafter referred to as first write command) instructing to store data into the 0^{th} to 255^{th} logical subunits of logical unit LBA(0), the memory control circuit unit 104 (or memory management circuit 502) may store the data of the first write command into the buffer memory 508 first. At this time, the memory control circuit unit 104 (or memory management circuit 502) may issue a first command sequence correspondingly since the write cache function has been disabled. In the present exemplary embodiment, the first command sequence is a flush command. The memory control circuit unit 104 (or memory management circuit 502) may program the data corresponding to the first write command from the buffer memory 508 to the rewritable non-volatile memory module 406 by using the single page programming mode according to the flush command.

For example, referring to FIG. 9, the memory control circuit unit 104 (or memory management circuit 502) may select two physical erasing units 510(F), 510(F+1) (hereinafter referred to as first physical erasing units) from the spare area 604 as the active physical erasing units corresponding to the first write command respectively. The memory control circuit unit 104 (or memory management circuit 502) may write the data of the first write command from the buffer memory 508 to the physical programming units (hereinafter referred to as first physical programming units) of the physical erasing unit 510(F) and the physical erasing unit 510(F+1) by using the single page programming mode according to the first command sequence. Herein, the physical erasing unit 510(F) and the physical erasing unit 510(F+1) are programmed by the single page programming mode. Accordingly, each memory cell constituting the physical erasing unit 510(F) and the physical erasing unit 510(F+1) is programmed to store one bit of data as mentioned above. That is, in the single page programming mode, the lower physical programming units of the physical erasing unit 510(F) and the physical erasing unit 510(F+1) are used to write data, and the upper physical programming units of the physical erasing unit 510(F) and the physical erasing unit 510(F+1) are not used to write data.

In detail, as shown in FIG. 9, the memory control circuit unit 104 (or memory management circuit 502) may sequentially write the data to be stored into the 0^{th} to 127^{th} logical subunits of the logical unit LBA(0) into the lower physical programming unit of the physical erasing unit 510(F), and sequentially write the data to be stored into the 128^{th} to 255^{th} logical subunits of the logical unit LBA(0) into the lower physical programming unit of the physical erasing unit 510(F+1). That is, the memory control circuit unit 104 (or memory management circuit 502) writes the data corresponding to the first write command into the lower physical programming unit of the physical erasing unit 510(F) of the rewritable non-volatile memory module 406 and the lower physical programming unit of the physical erasing unit 510(F+1) of the rewritable non-volatile memory module 406, and the upper physical programming unit of the physical erasing unit 510(F) and the upper physical programming unit of the physical erasing unit 510(F+1) are not used to write data.

After writing the data corresponding to the first write command from the buffer memory 508 into the lower physical programming unit of the physical erasing unit 510 (F) and the lower physical programming unit of the physical erasing unit 510(F+1) of the rewritable non-volatile memory module 460 by using the single page programming mode, the memory control circuit unit 104 (or memory management circuit 502) may associate the physical erasing unit 510(F) and the physical erasing unit 510(F+1) to the data area 602, and transmit write completion information to the host system 11 in response to the first write command issued by the host system 11. That is, in the present exemplary embodiment, after the write cache function has been disabled, if the host system 11 issues a write command and received the write completion information corresponding to the write command, it means that the data of the write command has already been stored into the rewritable non-volatile memory module 406 stably. Comparing to general write operations (i.e., the memory control circuit unit 104 (or memory management circuit 502) transmits write completion information to the host system 11 right after storing data into the buffer memory 508), the memory storage device 10 of the present exemplary embodiment can assure that the data of the write command is written into the rewritable non-volatile memory module 406 and avoid the loss of the data stored in the buffer memory 508 due to an unusual power interruption of the host system 11.

It should be mentioned that, when performing the write operation to the rewritable non-volatile memory module 406 by using the single page programming mode instead, the upper physical programming unit of the active physical erasing unit selected from the rewritable non-volatile memory module 406 is not used to write data, therefore the available capacity of the selected active physical erasing unit for writing data is only left with half of the original capacity of the physical erasing unit. In order not to reduce the storage capacity of the rewritable non-volatile memory module 406 in the single page programming mode, in the present exemplary embodiment, the memory control circuit unit 104 (or memory management circuit 502) may perform a valid data merging operation to the data written in the single page programming by using the multi-page programming mode.

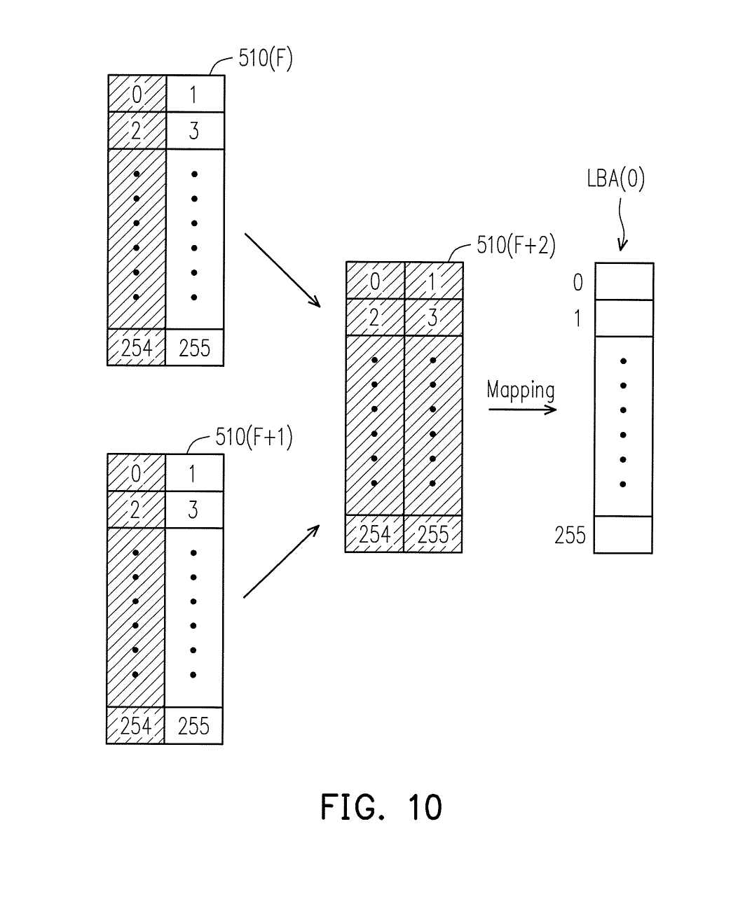

FIG. 10 is a schematic diagram of performing a valid data merging operation to data written in a single page programming mode by using a multi-page programming mode according to an exemplary embodiment.

Assuming that the physical erasing unit 510(F) and the physical erasing unit 510(F+1) of the logical unit LBA(0) has stored valid data of all logical subunits of the logical unit LBA(0) (as shown in FIG. 9). When the memory storage device 10 is in a background executing mode, for example, the memory storage device 10 is in an idle state for a period of time (i.e., no command (e.g., write command, read command, flush command, trim command, etc.) received from the host system 11 for 30 seconds), or the number of empty physical erasing units in the spare area 604 is smaller than a preset threshold, the memory control circuit unit 104 (or memory management circuit 502) may perform the valid data merging operation.

In detail, when the memory storage device 10 does not receive any commands from the host system 11 for 30 seconds because of being idle, or the number of empty physical erasing units in the spare area 604 is smaller than a preset threshold, the memory control circuit unit 104 (or memory management circuit 502) may perform the valid data merging operation. Referring to FIG. 10, when the memory control circuit unit 104 (or the memory management circuit 502) performs the valid data merging operation, the memory control circuit unit 104 (or the memory management circuit 502), for example, selects one physical erasing unit from the spare area 604 as physical erasing unit 510(F+2) (hereinafter referred to as third physical erasing unit) for substitution. Specifically, the memory control circuit unit 104 (or memory management circuit 502) selects one blank physical erasing unit or one physical erasing unit in which the data stored is invalid. Especially, if the selected physical erasing unit is the physical erasing unit with invalid data, the memory control circuit unit 104 (or memory management circuit 502) may first perform an erase operation to the physical erasing unit. In other words, the invalid data of the physical erasing unit should be erased at first.

Afterwards, the memory control circuit unit 104 (or memory management circuit 502) copies a plurality of valid data of the physical erasing unit 510(F) and the physical erasing unit 510(F+1) into physical programming units of the physical erasing unit 510(F+2) of the rewritable non-volatile memory module 406 by using the multi-page programming mode. Herein, the physical erasing unit 510(F+2) is programmed by the multi-page programming mode. Accordingly, each memory cell constituting the physical programming units of the physical erasing unit 510(F+2) is programmed to store multiple bits of data as mentioned above. That is, in the multi-page programming mode, both the lower physical programming unit of the physical erasing unit 510(F+2) and the upper physical programming unit of the physical erasing unit 510(F+2) are used to write data.

In detail, the memory control circuit unit 104 (or memory management circuit 502) may write (or copy) the valid data belonging to the 0^{th} to 127^{th} logical subunits of the logical unit LBA(0) into the corresponding pages of the physical erasing unit 510(F+2) (e.g., the 0^{th} to 127^{th} physical programming units). After that, the memory control circuit unit 104 (or memory management circuit 502) may copy the valid data belonging to the 128^{th} to 255^{th} logical subunits of the logical unit LBA(0) into the corresponding pages of the physical erasing unit 510(F+2) (e.g., the 128^{th} to 255^{th} physical programming units). That is, in the multi-page programming mode, the 0^{th} to 255^{th} physical programming units (hereinafter referred to as third physical programming unit) of the physical erasing unit 510(F+2) are used to write data.

That is, when performing the valid data merging operation, the physical erasing unit to be associated to the data area 602 is operated by using the multi-page programming mode. Accordingly, physical programming unit groups are taken as units of writing data into the physical erasing unit 510(F+2) simultaneously or periodically. Specifically, in one exemplary embodiment, the 0^{th} and the 1^{st} physical programming units of the physical erasing unit 510(F+2) are programmed simultaneously so as to be written in the data of the 0^{th} and the 1^{st} logical subunits of the logical unit LBA(0). The 2^{nd} and the 3^{rd} physical programming units of the physical erasing unit 510(F+2) are programmed simultaneously so as to be written in the data of the 2^{nd} and the 3^{rd} logical subunits of the logical unit LBA(0). And, it can be deduced that the data of the other logical subunits are written into the physical erasing unit 510(F+2) in units of the physical programming unit groups.

At last, the memory control circuit unit 104 (or memory management circuit 502) may map the logical unit LBA(0) to the physical erasing unit 510(F+2) in the logical address-physical address mapping table, perform an erasing operation to the physical erasing units 510(F)˜510(F+1) and re-associate the physical erasing units 510(F)˜510(F+1) to the spare area 604. That is, when executing the subsequent write commands, the erased physical erasing units 510(F)˜510(F+1) can be again selected as the active physical erasing unit of the logical unit to be written.

By performing the valid data merging operation aforementioned, it can be assured that the available storage capacity of the rewritable non-volatile memory module 406 does not reduce due to being written by using the single page programming mode previously.

It should be mentioned that, the user of the memory storage device 10 may further issue an enable write cache command through the host system 11. The memory control circuit unit 104 (or memory management circuit 502) may enable the write cache function in response to the enable write cache command after receiving the same, so as to restore the function of writing data by using the multi-page programming mode preset by the rewritable non-volatile memory module 406.

In detail, the memory control circuit unit 104 (or memory management circuit 502) may receive an enable write cache command issued by the user from the host system 11. After receiving the enable write cache command, the memory control circuit unit 104 (or memory management circuit 502) may enable the write cache function in response to the enable write cache command. Afterwards, when receiving the write command from the host system 11 again, the memory control circuit unit 104 (or memory management circuit 502) may store the data corresponding to the write command into the buffer memory 508 and immediately transmit write completion information corresponding to the third write command to the host system 11. At an appropriate moment thereafter, for example, when the memory control circuit unit 104 (or memory management circuit 502) receives a flush command from the host system 11, the amount of data in the buffer memory 508 reaches a threshold or the idle time of the host system 11 exceeds a threshold, the data stored in the buffer memory 508 is then written to at least one physical programming unit of at least one physical erasing unit of the rewritable non-volatile memory module 406 by using the multi-page programming mode. As mentioned above, in the multi-page programming mode, the lower physical programming unit and the upper physical programming unit of the physical erasing unit being used to write data are used to write data.

That is, the user of the memory storage device 10 can selectively use the disable write cache command or the enable write cache command to disable or enable the write cache function correspondingly.

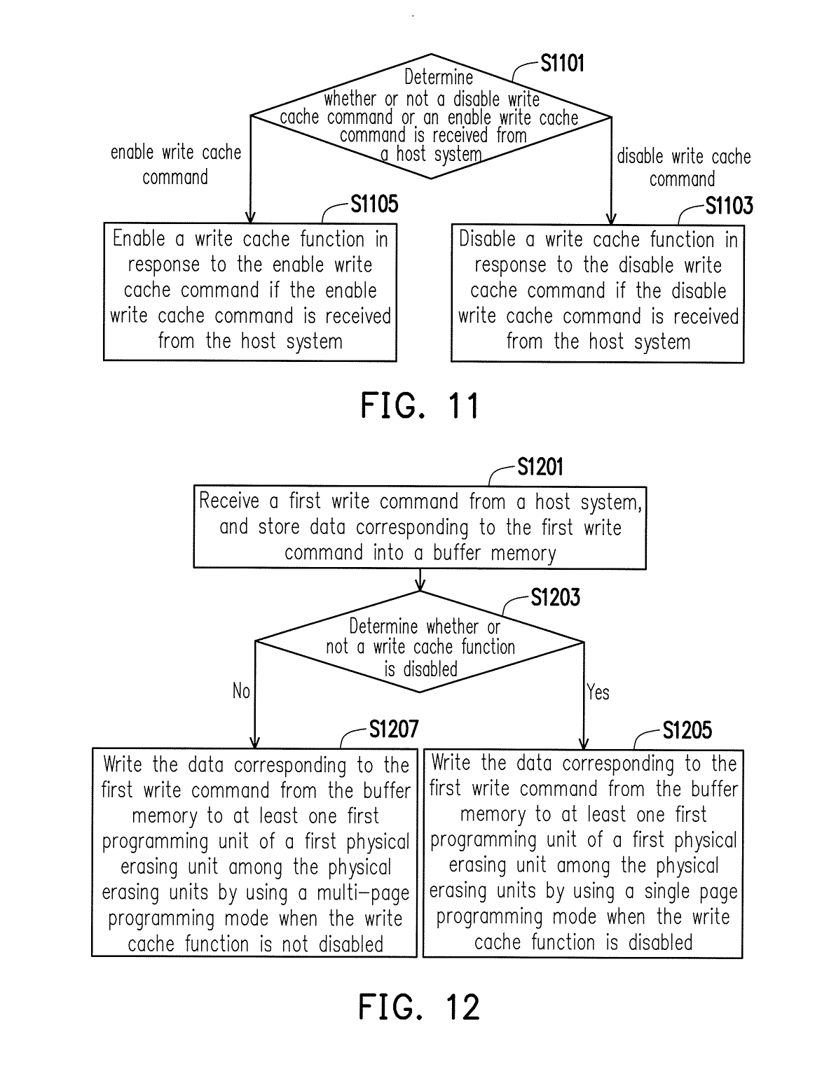

FIG. 11 and FIG. 12 are flowcharts of a data writing method according to an exemplary embodiment.

Referring to FIG. 11, in step S1101, the memory control circuit unit 104 (or memory management circuit 502) may determine whether a disable write cache command or an enable write cache command is received from the host system 11. If the memory control circuit unit 104 (or memory management circuit 502) receives the disable write cache command, in step S1103, the memory control circuit unit 104 (or memory management circuit 502) may disable a write cache function in response to the disable write cache command. If the memory control circuit unit 104 (or memory management circuit 502) receives the enable write cache command, in step S1105, the memory control circuit unit 104 (or memory management circuit 502) may enable the write cache function in response to the enable write cache command.

Referring to FIG. 12, in step S1201, the memory control circuit unit 104 (or memory management circuit 502) receives a first write command from the host system 11 and stores data corresponding to the first write command into a buffer memory 508. Afterwards, in step S1203, the memory control circuit unit 104 (or memory management circuit 502) may determine whether the write cache function is disabled. When the write cache function is disabled, in step S1205, the memory control circuit unit 104 (or memory management circuit 502) may issue a first command sequence to write the data corresponding to the first write command from the buffer memory 508 to at least one first physical programming unit of a first physical erasing unit among the physical erasing units by using a single page programming mode. For example, in an exemplary embodiment, the memory control circuit unit 104 (or memory management circuit 502) may immediately generate a flush command and write the data corresponding to the first write command from the buffer memory 508 to the first physical programming unit of the first physical erasing unit among the physical erasing units by using the single page programming mode according to the flush command.

On the other hand, when the write cache function is not disabled, in step S1207, the memory control circuit unit 104 (or memory management circuit 502) may issue a second command sequence to write the data corresponding to the first write command from the buffer memory 508 to the first physical programming unit of the first physical erasing unit among the physical erasing units by using a multi-page programming mode. However, it should be noted that, when the write cache function is not disabled and the data corresponding to the first write command is stored in the buffer memory, the memory control circuit unit 104 (or memory management circuit 502) may not perform the step S1207 immediately. Specifically, the memory control circuit unit 104 (or memory management circuit 502) may perform the step S1207 at an appropriate moment, for example, when a flush command is received from the host system 11, the amount of data in the buffer memory 508 reaches a threshold, or a background executing mode is entered.

Based on the above, the data writing method of the present invention can effectively prevent the loss of data stored in the buffer memory owing to an unusual power interruption of the host system, and assure that data of the write command is stably stored into the rewritable non-volatile memory before the unusual power interruption occurs. Besides, the data writing method of the present invention can also prevent the problem of “write amplification”, and effectively utilize the storage capacity of the rewritable non-volatile memory. The previously described exemplary embodiments of the present invention have the advantages aforementioned, wherein the advantages aforementioned not required in all versions of the invention.

Although the present invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A data writing method for a rewritable non-volatile memory module, wherein the rewritable non-volatile memory module comprises a plurality of physical erasing units, and each of the physical erasing unit comprises a plurality of physical programming units, the data writing method comprising:
receiving a first write command from a host system and storing data corresponding to the first write command into a buffer memory; and
writing the data corresponding to the first write command from the buffer memory to at least one first physical programming unit of a first physical erasing unit among the physical erasing units by using a single page programming mode if a write cache function is disabled and the data corresponding to the first write command is stored into the buffer memory,
wherein the at least one first physical programming unit is constituted by a plurality of first memory cells and each of the first memory cells only stores one bit of data in the single page programming mode.

2. The data writing method as claimed in claim 1, further comprising:
receiving a disable write cache command from the host system, and disabling the write cache function in response to the disable write cache command.

3. The data writing method as claimed in claim 2, wherein before the step of receiving the disable write cache command from the host system, the data writing method further comprising:
receiving a second write command from the host system and storing data corresponding to the second write command into the buffer memory; and
writing the data corresponding to the second write command stored in the buffer memory into at least one second physical programming unit of a second physical erasing unit among the physical erasing units by using a multi-page programming mode,
wherein the at least one second physical programming unit is constituted by a plurality of second memory cells and each of the second memory cells stores multiple bits of data in the multi-page programming mode.

4. The data writing method as claimed in claim 1, wherein after the step of writing the data corresponding to the first write command from the buffer memory to the at least one first physical programming unit of the first physical erasing unit among the physical erasing units by using the single page programming mode, the data writing method further comprising:
transmitting write completion information to the host system.

5. The data writing method as claimed in claim 1, further comprising:
issuing a flush command to perform the step of writing the data corresponding to the first write command from the buffer memory to the at least one first physical programming unit of the first physical erasing unit by using the single page programming mode if the write cache function is disabled and the data corresponding to the first write command is stored into the buffer memory.

6. The data writing method as claimed in claim 1, further comprising:
performing a valid data merging operation in a background executing mode to copy a plurality of valid data of the first physical erasing unit into a plurality of third physical programming units of a third physical erasing unit among the physical erasing units by using the multi-page programming mode,
wherein the third programming units are constituted by a plurality of third memory cells and each of the third memory cells constituted by the third physical programming units stores multiple bits of data in the multi-page programming mode.

7. The data writing method as claimed in claim 1, further comprising:
receiving an enable write cache command, and enabling the write cache function in response to the enable write cache command.

8. The data writing method as claimed in claim 1, wherein
the multi-page programming mode is a multi level cell programming mode or a trinary level cell programming mode, and the single page programming mode is a single level cell programming mode, a lower physical programming mode, a mixture programming mode or a less layer memory cell mode.

9. A memory control circuit unit for controlling a rewritable non-volatile memory module, the memory control circuit unit comprising:
a host interface configured to coupled to a host system;
a memory interface configured to couple to the rewritable non-volatile memory module, wherein the rewritable non-volatile memory module comprises a plurality of physical erasing units, and each of the physical erasing units comprises a plurality of physical programming units;
a buffer memory coupled to the host interface and the memory interface; and
a memory management circuit coupled to the host interface, the memory interface and the buffer memory,
wherein the memory management circuit is configured to receive a first write command from the host system and store data corresponding to the first write command into the buffer memory,
wherein the memory management circuit is further configured to issue a first command sequence to write the data corresponding to the first write command from the buffer memory to at least one first physical programming unit of a first physical erasing unit among the physical erasing units by using a single page programming mode if a write cache function is disabled and the data corresponding to the first write command is stored into the buffer memory,
wherein the at least one first physical programming unit is constituted by a plurality of first memory cells and each of the first memory cells only stores one bit of data in the single page programming mode.

10. The memory control circuit unit as claimed in claim 9, wherein
the memory management circuit is further configured to receive a disable write cache command from the host system, and disable the write cache function in response to the disable write cache command.

11. The memory control circuit unit as claimed in claim 10, wherein before the operation of receiving the disable write cache command from the host system,
the memory management circuit is further configured to receive a second write command from the host system and store data corresponding to the second write command into the buffer memory, and
the memory management circuit is further configured to issue a second command sequence to write the data corresponding to the second write command stored in the buffer memory into at least one second physical programming unit of a second physical erasing unit among the physical erasing units by using a multi-page programming mode,
wherein the at least one second physical programming unit is constituted by a plurality of second memory cells and each of the second memory cells stores multiple bits of data in the multi-page programming mode.

12. The memory control circuit unit as claimed in claim 9, wherein after the operation of writing the data corresponding to the first write command from the buffer memory to the at least one first physical programming unit of the first physical erasing unit among the physical erasing units by using the single page programming mode,
the memory management circuit is further configured to transmit write completion information to the host system.

13. The memory control circuit unit as claimed in claim 9, wherein the first command sequence is a flush command, and
the memory management circuit is further configured to write the data corresponding to the first write command from the buffer memory to the at least one first physical programming unit of the first physical erasing unit by using the single page programming mode according to the flush command if the write cache function is disabled and the data corresponding to the first write command is stored into the buffer memory.

14. The memory control circuit unit as claimed in claim 9, wherein
the memory management circuit is further configured to perform a valid data merging operation in a background executing mode to copy a plurality of valid data of the first physical erasing unit into a plurality of third physical programming units of a third physical erasing unit among the physical erasing units by using the multi-page programming mode,
wherein the third programming units are constituted by a plurality of third memory cells and each of the third memory cells constituted by the third physical programming units stores multiple bits of data in the multi-page programming mode.

15. The memory control circuit unit as claimed in claim 9, wherein
the memory management circuit is further configured to receive an enable write cache command, and enable the write cache function in response to the enable write cache command.

16. The memory control circuit unit as claimed in claim 9, wherein the multi-page programming mode is a multi level cell programming mode or a trinary level cell programming mode, and the single page programming mode is a single level cell programming mode, a lower physical programming mode, a mixture programming mode or a less layer memory cell mode.

17. A memory storage device, comprising:
a connection interface unit configured to couple to a host system;
a rewritable non-volatile memory module comprising a plurality of physical erasing units, and each of the physical erasing units comprising a plurality of physical programming units; and
a memory control circuit unit coupled to the connection interface unit and the rewritable non-volatile memory module, and comprising a buffer memory,
wherein the memory control circuit unit is configured to receive a first write command from the host system and store data corresponding to the first write command into the buffer memory,
wherein the memory control circuit unit is further configured to issue a first command sequence to write the data corresponding to the first write command from the buffer memory to at least one first physical programming unit of a first physical erasing unit among the physical erasing units by using a single page programming mode if a write cache function is disabled and the data corresponding to the first write command is stored into the buffer memory,
wherein the at least one first physical programming unit is constituted by a plurality of first memory cells and each of the first memory cells only stores one bit of data in the single page programming mode.

18. The memory storage device as claimed in claim 17, wherein
the memory control circuit unit is further configured to receive a disable write cache command from the host system, and disable the write cache function in response to the disable write cache command.

19. The memory storage device as claimed in claim 18, wherein before the operation of receiving the disable write cache command from the host system,
the memory control circuit unit is further configured to receive a second write command from the host system and store data corresponding to the second write command into the buffer memory, and
the memory control circuit unit is further configured to issue a second command sequence to write the data corresponding to the second write command stored in the buffer memory into at least one second physical programming unit of a second physical erasing unit among the physical erasing units by using a multi-page programming mode,
wherein the at least one second physical programming unit is constituted by a plurality of second memory cells and each of the second memory cells stores multiple bits of data in the multi-page programming mode.

20. The memory storage device as claimed in claim 17, wherein after the operation of writing the data corresponding to the first write command from the buffer memory to the at least one first physical programming unit of the first physical erasing unit among the physical erasing units by using the single page programming mode,
the memory control circuit unit is further configured to transmit write completion information to the host system.

21. The memory storage device as claimed in claim 17, wherein the first command sequence is a flush command, and
the memory control circuit unit is further configured to write the data corresponding to the first write command from the buffer memory to the at least one first physical programming unit of the first physical erasing unit by using the single page programming mode according to the flush command if the write cache function is disabled and the data corresponding to the first write command is stored into the buffer memory.

22. The memory storage device as claimed in claim 17, wherein
the memory control circuit unit is further configured to perform a valid data merging operation in a background executing mode to copy a plurality of valid data of the first physical erasing unit into a plurality of third physical programming units of a third physical erasing unit among the physical erasing units by using the multi-page programming mode,
wherein the third programming units are constituted by a plurality of third memory cells and each of the third memory cells constituted by the third physical programming units stores multiple bits of data in the multi-page programming mode.

23. The memory storage device as claimed in claim 17, wherein
the memory control circuit unit is further configured to receive an enable write cache command, and enable the write cache function in response to the enable write cache command.

24. The memory storage device as claimed in claim 17, wherein the multi-page programming mode is a multi level cell programming mode or a trinary level cell programming mode, and the single page programming mode is a single level cell programming mode, a lower physical programming mode, a mixture programming mode or a less layer memory cell mode.
